(19) United States
(12) Patent Application Publication
(10) Pub. No.: US 2020/0073569 A1
(43) Pub. Date: Mar. 5, 2020

(54) STORAGE CONTROL SYSTEM AND STORAGE CONTROL METHOD

(71) Applicant: FUJITSU LIMITED, Kawasaki-shi (JP)

(72) Inventors: Guangyu ZHOU, Kawasaki (JP); Yukari Tsuchiyama, Kawasaki (JP); Chikashi Maeda, Kawasaki (JP)

(73) Assignee: FUJITSU LIMITED, Kawasaki-shi (JP)

(21) Appl. No.: 16/555,323

(22) Filed: Aug. 29, 2019

(30) Foreign Application Priority Data
Sep. 4, 2018 (JP) 2018-165053

(51) Int. Cl. G06F 3/06; G06F 13/40; G06F 13/42

(52) U.S. Cl. CPC G06F 3/0632; G06F 3/0689; G06F 3/0659; G06F 2213/0026; G06F 13/4027; G06F 13/4282; G06F 3/0604

(57) ABSTRACT

A storage control system includes one or more memories, and one or more processors configured to acquire first processing performance of a storage device at a first time and second processing performance of the storage device at a second time before the first time, perform determination of multiplicity of logical formatting for the storage device based on a difference between the first processing performance and the second processing performance, and perform, based on the determined multiplicity, issuance of one or more logical formatting commands to the storage device.

### CROSS-REFERENCE TO RELATED APPLICATION

This application is based upon and claims the benefit of priority of the prior Japanese Patent Application No. 2018-165053, filed on Sep. 4, 2018, the entire contents of which are incorporated herein by reference.

### FIELD

The embodiment relates to a storage control technique.

### BACKGROUND

In a storage device, a controller module (CM) writes 0s to a memory region of a memory device such as a hard disk drive (HDD) or a solid state drive (SSD) to format (initialize) the memory device in order to use the memory device.

The CM executes logical formatting (LF) to write a block check code (BCC) to a storage medium in the formatting of the storage medium.

FIG. 5 is a diagram illustrating a configuration of a data block. The data block illustrated in FIG. 5 is configured by adding a BCC of 8 bytes to data of 512 bytes. The BCC is information to be used to confirm the validity of the logical data block and includes a redundant code (block CRC) for detecting an abnormality of data, and positional information (block ID) for checking a logical data position of the data block. CRC is an abbreviation for cyclic redundancy check. ID is an abbreviation for identification.

The CM enables the logical formatting by sequentially issuing a single LF command to the memory device. After a previously issued LF command is completely processed, a next LF command is issued to execute the LF on the memory device.

For example, related techniques have been disclosed in Japanese Laid-open Patent Publication No. 2014-41431 and Japanese Laid-open Patent Publication No. 2001-22526.

### SUMMARY

According to an aspect of the embodiments, a storage control system includes one or more memories, and one or more processors configured to acquire first processing performance of a storage device at a first time and second processing performance of the storage device at a second time before the first time, perform determination of multiplicity of logical formatting for the storage device based on a difference between the first processing performance and the second processing performance, and perform, based on the determined multiplicity, issuance of one or more logical formatting commands to the storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram exemplifying a configuration of a storage device as an example of an embodiment;

FIG. 2 is a diagram exemplifying a hardware configuration of each of CMs of the storage device as the example of the embodiment;

FIG. 3 is a diagram describing a process to be executed by an LF controller and an LF executing section that are included in the storage device as the example of the embodiment;

FIGS. 4A and 4B are flowcharts describing a process to be executed by the LF controller of the storage device as the example of the embodiment; and

FIG. 5 is a diagram illustrating a configuration of a data block.

### DESCRIPTION OF EMBODIMENTS

In recent years, capacities of memory devices have been increased. For example, SSDs with capacities of 30 TB, 64 TB, 128 TB, and the like are known. While capacities of such memory devices are increased, there is a problem that time periods for executing logical formatting increase. For example, it may take one week or more to execute logical formatting on a memory device.

Hereinafter, an embodiment of a storage control system and a storage control method is described with reference to the drawings. The following embodiment, however, is an example and is not intended to exclude the application of various modifications and techniques that are not clearly described in the embodiment. That is, various modifications and changes may be included in the embodiment without departing from the gist of the embodiment. The drawings are not intended to illustrate that only the drawn components are provided, but the embodiment may include other functions and so on.

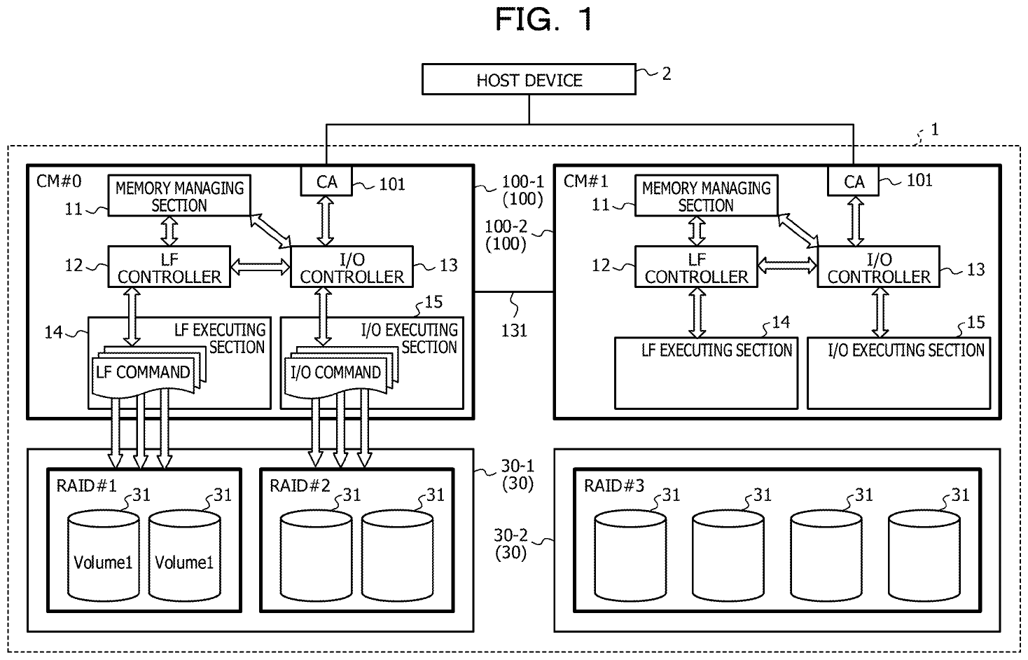

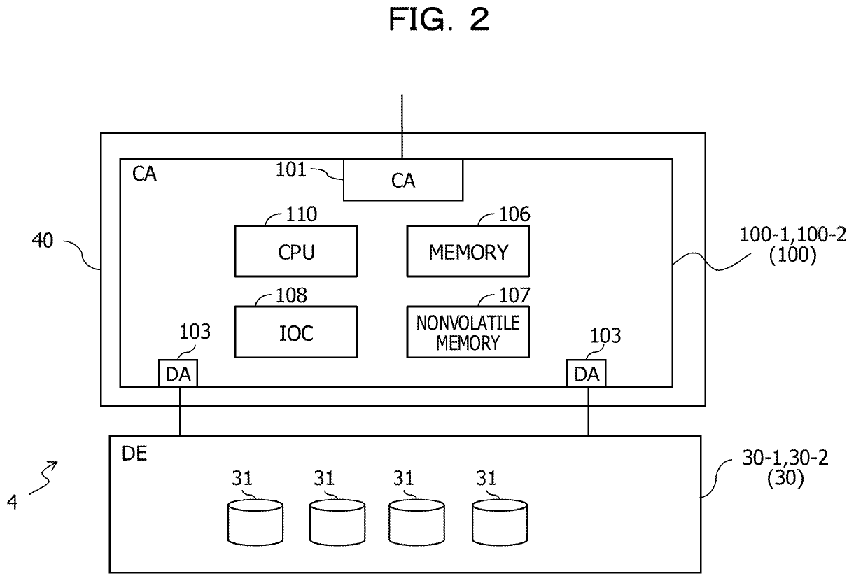

FIG. 1 is a diagram exemplifying a configuration of a storage device 1 as an example of the embodiment. FIG. 2 is a diagram exemplifying a hardware configuration of each of CMs 100 of the storage device 1 as the example of the embodiment. The storage device 1 virtualizes memory devices 31 stored in drive enclosures (DE) 30 to form a virtual storage environment. The storage device 1 provides virtual volumes to a host device (server) 2 that is a high-level device. The storage device 1 is an example of the storage control system

The storage device 1 is coupled to and able to communicate with one or more (one host device 2 in the example illustrated in FIG. 1) host devices 2. The host device 2 and the storage device 1 are coupled to each other by communication adapters (CAs) 101 described later.

The host device 2 is, for example, an information processing device having a server function. The host device 2 transmits and receives commands for network attached storage (NAS) and a storage area network (SAN) to and from the storage device 1. The host device 2 transmits a storage access command to execute reading or writing on the storage device 1, thereby reading or writing data from or to a volume among the volumes provided by the storage device 1.

Then, the storage device 1 executes a process of reading or writing the data from or to a memory device 31 corresponding to the volume in accordance with an input or output request (for example, a read request or a write request) issued by the host device 2 to the volume. Hereinafter, the input or output request from the host device 2 is referred to as I/O request in some cases.

As illustrated in FIG. 1, the storage device 1 includes one or more (two in the example illustrated in FIG. 1) CMs 100-1 and 100-2 and one or more (two in the example illustrated in FIG. 2) DEs 30-1 and 30-2.

Each of the DEs 30-1 and 30-2 includes one or more (four in the example illustrated in FIG. 1) memory devices (physical disks) 31 and provides memory regions (actual volumes or actual storage) of the one or more memory devices 31 to the storage device 1.

In the example illustrated in FIG. 1, the DE 30-1 is coupled to the CM 100-1, and the DE 30-2 is coupled to the CM 100-2. As a reference indicating any of the DEs, the reference “30-1” or “30-2” is used to identify a corresponding one of the multiple DEs, but the reference “30” is used to indicate arbitrary one or more of the multiple DEs.

For example, each of the DEs 30 includes slots (not illustrated) at multiple stages. An actual volume capacity of each of the DEs 30 may be changed by attaching one or more memory devices 31 to one or more of the slots of each of the DEs 30. In addition, multiple memory devices 31 may be used to form redundant arrays of inexpensive disks (RAIDs).

In the example illustrated in FIG. 1, two of the four memory devices 31 included in the DE 30-1 are used to form a RAID #1, and the other two memory devices 31 included in the DE 30-1 are used to form a RAID #2. In addition, the four memory devices 31 included in the DE 30-2 are used to form a RAID #3.

The memory devices 31 are storage such as HDDs or SSDs. The memory devices 31 have larger capacities than those of memories 106 described later and store various data. The memory devices are hereinafter also referred to as drives or disks.

As illustrated in FIG. 2, the DE 30-1 is coupled to device adapters (DAs) 103 and 103 of the CM 100-1. The DE 30-2 is coupled to DAs 103 and 103 of the CM 100-2.

The DE 30-1 may be coupled to the DAs 103 and 103 of the CM 100-2. The DE 30-2 may be coupled to the DAs 103 and 103 of the CM 100-1. Each of the CMs 100-1 and 100-2 may access each of the DEs 30 to read and write data from and to each of the DEs 30. By coupling each of the CMs 100-1 and 100-2 to memory devices 31 included in a respective one of the DEs 30, access paths to the memory devices 31 are made redundant.

The CMs 100-1 and 100-2 are control devices (controllers or storage control devices) for controlling operations within the storage device 1. The CMs 100-1 and 100-2 execute various types of control such as data access control to the memory devices 31 of the DEs 30 in accordance with an I/O request transmitted by the host device 2. The CMs 100-1 and 100-2 have the same configuration. As a reference indicating any of the CMs, the reference 100-1 or 100-2 is used to identify a corresponding one of the multiple CMs, but the reference 100 is used to indicate arbitrary one or more of the CMs. The CM 100-1 may be referred to as CM #1, and the CM 100-2 may be referred to as CM #2.

The CMs 100-1 and 100-2 are made redundant. For example, the CM 100-1 (CM #1) normally executes various types of control while serving as a primary CM. However, when the primary CM 100-1 fails, the secondary CM 100-2 (CM #2) takes over an operation of the CM 100-1 and serves as the primary CM.

The CMs 100-1 and 100-2 are coupled to the host device 2 via the CAs 101. Each of the CMs 100 may include multiple CAs 101, and paths between each of the CMs 100 and the host device 2 may be made redundant.

Each of the CMs 100 receives an I/O request, which is a read request or a write request and has been transmitted by the host device 2, and controls, via the DAs 103 of the CM 100, the memory devices 31 coupled to the CM 100. For example, the CMs 100 correspond to storage control devices for controlling the memory devices 31.

The CMs 100-1 and 100-2 are coupled to and able to communicate with each other via a communication bus 131, as illustrated in FIG. 1. Thus, the CMs 100-1 and 100-2 enable inter-CM communication. The communication bus 131 may be a Peripheral Component Interconnect Express (PCIe) bus or may be a bus conforming to a standard other than PCIe. The CMs 100-1 and 100-2 may be included in a controller enclosure (CE) (not illustrated).

Each of the CMs 100 includes a CA 101, multiple (two in the example illustrated in FIG. 2) DAs 103 and 103, a central processing unit (CPU) 110, a memory 106, a nonvolatile memory 107, and an input output controller (IOC) 108, which are coupled to and able to communicate with each other via, for example, PCIe interfaces.

The CA 101 is an adapter configured to receive data from the host device 2 and the like and transmit data from the concerned CM 100 to the host device 2 and the like. The CA 101 controls input and output of data from and to an external device such as the host device 2.

The CA 101 is a network adapter coupled to and able to communicate with the host device 2 via, for example, the NAS. For example, the CA 101 is a local area network (LAN) interface or the like. The CMs 100 are coupled to the host device 2 or the like via the CAs 101 and communication lines (not illustrated). Each of the CMs 100 receives an I/O request from the host device 2 or the like and transmits and receives data to and from the host device 2 or the like. In the example illustrated in FIG. 2, each of the CMs 100-1 and 100-2 includes a respective one CA 101.

The CA 101 may be a network adapter coupled to and able to communicate with the host device 2 via the SAN. For example, the CA 101 may be an Internet Small Computer System Interface (iSCSI) or a Fibre Channel (FC) interface. The CMs 100 may be coupled to the host device 2 or the like via the CAs 101 and the communication lines (not illustrated). Each of the CMs 100 may receive an I/O request from the host device 2 or the like and transmit and receive data to and from the host device 2 or the like.

The DAs 103 are interfaces to be coupled to and able to communicate with a DE 30 coupled to the concerned CM 100, memory devices 31 included in the DE 30, and the like. The memory devices 31 of the DE 30 are coupled to the DAs 103. The CMs 100 control access to the memory devices 31 based on an I/O request received from the host device 2.

The CMs 100 write and read data to and from the memory devices 31 via the DAs 103. Each of the CMs 100-1 and 100-2 includes two DAs 103 and 103. Each of the DEs 30 is coupled to the DAs 103 of a respective one of the CMs 100-1 and 100-2.

The nonvolatile memory 107 is a memory device for storing various data, a program to be executed by the CPU 110, and the like.

The memory (main memory) 106 is a memory device for temporarily storing various data and the program and for storing a storage control program. The memory 106 has a cache region. The storage control program includes multiple commands to be executed by the CPU 110 to enable control functions (for example, functions as a memory managing section 11, an LF controller 12, an input and output (I/O) controller 13, an LF executing section 14, and an I/O executing section 15, which are illustrated in FIG. 1) according to the embodiment. The storage control program is stored in the memory 106 or the nonvolatile memory 107. The cache region temporarily stores data received from the host device 2 and data to be transmitted to the host device 2. The access speed of the memory 106 is higher than the access speed of each of the memory devices (drives) 31, but the memory 106 has a capacity smaller than the capacity of each of the memory devices (drives) 31. The memory 106 is a random access memory (RAM) or the like. In the concerned CM 100, the memory 106 is a hardware resource to be used to execute logical formatting (LF) on memory regions of the memory devices 31.

The IOC 108 is a control device for controlling data transfer in the concerned CM 100. For example, the IOC 108 enables direct memory access (DMA) transfer, which is executed to transfer data stored in the memory 106 without the CPU 110.

The CPU 110 is a processing device for executing various types of control and calculation. The CPU 110 is, for example, a multicore processor (multicore CPU). The CPU 110 enables various functions by executing an operating system (OS) and the program that are stored in the memory 106, the nonvolatile memory 107, or the like. In the embodiment, the CPU 110 executes the storage control program, thereby functioning as the memory managing section 11, the LF controller 12, the I/O controller 13, the LF executing section 14, and the I/O executing section 15, which are described later.

The program (storage control program), which enables the functions as the memory managing section 11, the LF controller 12, the I/O controller 13, the LF executing section 14, and the I/O executing section 15, is provided while being recorded in a computer-readable recording medium such as a flexible disk, a CD (CD-ROM, CD-R, CD-RW, or the like), a DVD (DVD-ROM, DVD-RAM, DVD-R, DVD+R, DVD-RW, DVD+RW, HD DVD, or the like), a Blu-ray disc, a magnetic disk, an optical disc, or a magneto-optical disc. A computer reads the program from the recording medium, transfers the read program to an internal or external memory device, causes the program to be stored in the internal or external memory device, and uses the program. For example, the program may be recorded in a memory device (recording medium) such as a magnetic disk, an optical disc, or a magneto-optical disc and may be provided from the memory device to the computer via a communication path.

To enable the functions as the memory managing section 11, the LF controller 12, the I/O controller 13, the LF executing section 14, and the I/O executing section 15, the program stored in the internal or external memory device (memory 106 in the embodiment) is executed by a microprocessor (CPU 110 in the embodiment) of the computer. In this case, the computer may read and execute the program recorded in the recording medium.

The I/O controller 13 controls input and output (I/O) access to the memory devices 31. For example, the I/O controller 13 instructs the I/O executing section 15 to execute reading or writing from and to a memory device 31 or an access destination in accordance with an I/O request from the host device 2. The I/O controller 13 has a function of managing an I/O request issued by the host device 2 to the concerned CM 100. Thus, the LF controller 12 described later may check with the I/O controller 13 to recognize whether an I/O request has been issued by the host device 2 to the concerned CM 100.

The I/O executing section 15 executes the I/O access to the memory device 31 in accordance with the instruction from the I/O controller 13. For example, the I/O executing section 15 issues an I/O command such as a read command or a write command to the memory device 31 to be accessed, thereby executing the I/O access to the memory device 31 to be accessed for reading or writing. The functions as the I/O controller 13 and the I/O executing section 15 may be enabled using any one or more of known various methods and will not be described in detail.

The memory managing section 11 manages a memory capacity related to the execution of the LF. For example, the memory managing section 11 manages a first memory capacity and a second memory capacity.

In the concerned CM 100, the first memory capacity is the size (memory capacity) of a region that is among memory regions of the memory 106 and has been allocated for the execution of the LF in advance and is used to execute the logical formatting. The first memory capacity is, for example, 6 MB. The first memory capacity is hereinafter indicated by (A) in some cases. The first memory capacity indicates a capacity allocated for the logical formatting of the hardware resource (memory 106) of the concerned CM 100. The first memory capacity corresponds to a first capacity allocated for the logical formatting to be executed on the hardware resource of the CM 100.

The second memory capacity is a memory capacity for a single-unit logical formatting operation (single-unit LF operation) set based on a RAID configuration.

The second memory capacity is, for example, a value determined based on a boundary size (stripe size) of a stripe of RAIDs. The second memory capacity is, for example, 1.5 MB. The second memory capacity is hereinafter indicated by (B) in some cases.

By accessing the memory devices 31 using data with a size based on the boundary size of the stripe of the RAIDs in the execution of the LF, an access efficiency, which is equal to or nearly equal to the efficiency of access made in accordance with a normal I/O request from the host device 2, may be obtained.

The second memory capacity corresponds to a standard memory capacity set based on the RAID configuration and related to the execution of the LF.

The first memory capacity and the second memory capacity may be defined by a system administrator or the like and stored as device configuration information in a predetermined region of the nonvolatile memory 107. The memory managing section 11 may acquire the first memory capacity and the second memory capacity by reading values of the first and second memory capacities from the device configuration information upon the activation of the storage device 1.

The memory managing section 11 causes the acquired first and second memory capacities to be stored in a predetermined region of the memory 106.

The LF controller 12 determines the number of LF commands to be simultaneously issued by the LF executing section 14 (described later) to the memory devices 31. The number of LF commands to be simultaneously issued by the LF executing section 14 to the memory devices 31 is hereinafter referred to as LF command multiplicity in some cases.

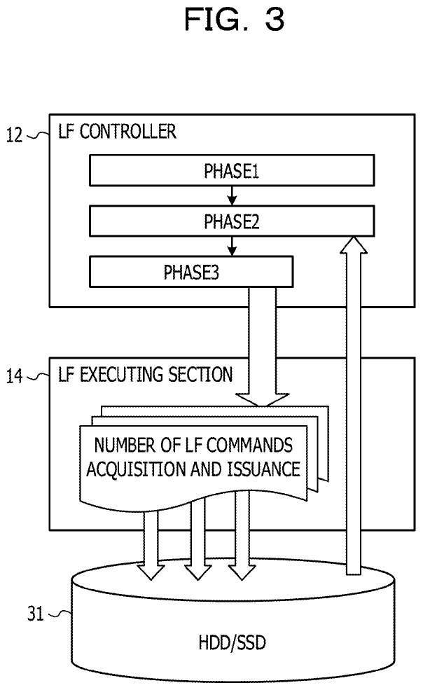

FIG. 3 is a diagram describing a process to be executed by the LF controller 12 and the LF executing section 14 that are included in the storage device 1 as the example of the embodiment. The LF controller 12 determines the LF command multiplicity by sequentially executing processes of phases 1 to 3 described later. In the storage device 1, the LF command multiplicity includes the number of continuous LF processes and the number of new LF processes. Then, the LF controller 12 notifies the number of continuous LF processes and the number of new LF processes to the LF executing section 14.

The number of continuous LF processes is the number of LF commands that have been issued by the LF executing section 14 and are being processed. The LF controller 12 has a function of managing the number of LF commands issued by the LF executing section 14 to the memory devices 31 and may recognize the number of continuous LF processes. The number of new LF processes is the number of LF commands to be issued by the LF executing section 14.

Hereinafter, a series of processes, which are executed on a single LF command and are from the issuance of the LF command by the LF controller 12 to the LF executing section 14 (described later) to the completion of the processes executed on the issued LF command, are collectively referred to as LF command process in some cases. In addition, a single LF command is also referred to as single unit.

In the phase 1, the LF controller 12 determines an “LF multiplicity upper limit per CM”. The LF multiplicity upper limit per CM is the maximum number of LF commands able to be simultaneously issued in parallel (multiple issuance) in the single CM 100 and is determined based on a limit on the hardware resource of the CM 100. For example, the LF multiplicity upper limit per CM is determined based on a limit on the capacity of the memory 106 included in the concerned CM 100.

For example, the LF controller 12 determines the LF multiplicity upper limit per CM by dividing the first memory capacity by the second memory capacity. The LF multiplicity upper limit per CM is hereinafter indicated by (C) in some cases. The LF controller 12 calculates the LF multiplicity upper limit (C) per CM based on the following Equation (1).

The LF multiplicity upper limit (C) per CM=the first memory capacity (A)/the second memory capacity (B) (1)

For example, when the first memory capacity is 6 MB (A=6 MB), and the second memory capacity is 1.5 MB (B=1.5 MB), the LF multiplicity upper limit (C) per CM=4 (=6 MB/1.5 MB) (C=4). In this example, from the perspective of the limit on the capacity of the memory 106 of the CM 100, an upper limit on the LF command multiplicity is 4.

The process of the phase 1 is executed by the LF controller 12 only once when the LF controller 12 receives a command to execute the formatting from an operator and starts the LF.

For example, the LF multiplicity upper limit (C) per CM is determined in response to the start of the logical formatting (or at the time of volume generation). The LF multiplicity upper limit (C) per CM is an initial value of a unit of the logical formatting. For example, the LF multiplicity upper limit (C) per CM is used as an initial value of an operational multiplicity (D) (corresponding RAID multiplicity upper limit (E)) in the phase 2 described later.

In the phase 1, the LF controller 12 may acquire a resource, which is a memory region included in the memory 106 and to be used for the LF command process or the like.

In the phase 2, the LF controller 12 determines the “operational multiplicity”. The operational multiplicity is hereinafter indicated by (D) in some cases.

The operational multiplicity (D) is the number (issuance multiplicity) of LF commands to be simultaneously issued by the CM 100 (concerned CM 100) in which the concerned LF controller 12 operates. The operational multiplicity (D) is determined based on a load applied due to the execution of the LF and an I/O request from the host device 2.

To determine the operational multiplicity (D), the LF controller 12 uses a “corresponding RAID multiplicity upper limit” as a variable. The corresponding RAID multiplicity upper limit is hereinafter indicated by (E) in some cases. A corresponding RAID multiplicity upper limit (E) is set for each of RAIDs. The LF multiplicity upper limit (C) per CM that has been determined in the phase 1 may be used as an initial value of the corresponding RAID multiplicity upper limit (E).

The process of the phase 2 is executed by the LF controller 12 when the LF controller 12 receives a command to execute the formatting from the operator and starts the LF. In addition, the process of the phase 2 is executed every time the LF command process is completely executed on a single unit. In other words, the process of the phase 2 is executed every time the LF command process is completely executed on a single command.

When an I/O request is already issued by the host device 2, the LF controller 12 sets 1 to the operational multiplicity (D) (D=1) to inhibit a response to the I/O request from being affected. When the operational multiplicity (D) is 1, only one LF command is issued. In the storage device 1, the I/O request from the host device 2 is processed in priority to the LF.

In the case where the LF controller 12 executes the LF on memory devices 31 forming a single RAID (also referred to as RAID to be processed), when the LF is being executed on another RAID, the LF controller 12 compares a corresponding RAID multiplicity upper limit (E) of the RAID to be processed with a corresponding RAID multiplicity upper limit (E) of the other RAID. Then, the LF controller 12 sets, as the operational multiplicity (D), a quotient (integral part) of the division of a smaller one of the corresponding RAID multiplicity upper limits (E) of the RAID to be processed and the other RAID by the number of RAIDs being operated under management by the concerned CM 100.

For example, it is assumed that the corresponding RAID multiplicity upper limit (E) of the RAID to be processed is 6, the corresponding RAID multiplicity upper limit (E) of the other RAID is 3, and the number of RAIDs being operated under management by the concerned CM 100 is 2.

Since the “corresponding RAID multiplicity upper limit (E=6) of the RAID to be processed”>the “corresponding RAID multiplicity upper limit (E=3) of the other RAID”, the LF controller 12 divides the smaller corresponding RAID multiplicity upper limit (E=3) by the number (=2) of RAIDs being operated, thereby calculating 3/2=1.5, which is nearly equal to 1. The result of the division is rounded down to the closest whole number.

The LF controller 12 sets 1 obtained by the aforementioned calculation as the operational multiplicity (D) of the RAID to be processed (D=1). When multiple RAIDs are being operated, and the LF is being executed on another RAID, a load of the CM 100 is reduced by reducing the multiplicity based on the number of RAIDs being operated. As described above, the corresponding RAID multiplicity upper limit (E) is divided by the number of RAIDs being operated in the aforementioned manner. Thus, as the number of RAIDs being operated is larger, the multiplicity is smaller.

When the LF is not being executed on the other RAID, the LF controller 12 periodically monitors the throughput and adjusts the multiplicity without excessively acquiring a resource per CM 100. The LF controller 12 determines an increase or decrease in the throughput of the memory devices 31 after the start of the LF. The throughput is the amount of data able to be processed within a fixed time period and indicates input and output performance (processing performance) of the memory devices 31. The throughput is expressed in MB per second.

The LF controller 12 has a function of measuring (sampling) the throughput of each of the memory devices 31 and recording the throughput in a predetermined region of the memory 106 or a predetermined region of each of the memory devices 31. For example, the LF controller 12 has a function as an input and output performance acquirer for acquiring input and output performance of each of the memory devices 31.

For example, the LF controller 12 confirms an increase or decrease in the throughput of each of the memory devices 31 by comparing (latest) throughput of each of the memory devices 31 at current time with throughput, acquired at a time that is earlier than the current time by a predetermined time period T (of, for example, 5 seconds), of each of the memory devices 31. For example, the LF controller 12 compares the lastly acquired throughput (input and output performance) with the throughput acquired at the time of previous sampling. When the throughput of the memory devices 31 increases and is higher than the throughput acquired at the time that is earlier than the current time by the predetermined time period T, the LF controller 12 increases the operational multiplicity (D). When the throughput of the memory devices 31 decreases and is lower than the throughput acquired at the time that is earlier than the current time by the predetermined time period T, the LF controller 12 reduces the operational multiplicity (D).

When the lastly acquired throughput (input and output performance) is higher than the throughput acquired at the time of the previous sampling, the LF controller 12 increases the LF command multiplicity (multiplicity).

Thus, one or more LF commands may be issued in accordance with the multiplicity based on the processing performance (load state) of the memory devices 31. For example, when the throughput is higher than the throughput acquired at the time that is earlier than the current time by the predetermined time period T, a larger number of LF commands may be executed in parallel and a time period for executing the LF may be reduced by increasing the LF command multiplicity.

As described above, the process of the phase 2 is executed every time the LF command process executed on a single unit is completed (the completion of a single-unit operation). For example, every time the LF command process executed on a single LF command is completed, the process of the phase 2 is executed and a value of the operational multiplicity (D) is updated.

In the phase 3, the LF controller 12 determines the “number of continuous LF processes” and the “number of new LF processes” as the LF command multiplicity.

The number of continuous LF processes is the number of LF commands that have been issued by the CM 100 and are being processed. In other words, the number of continuous LF processes is the number of incomplete commands issued by the LF executing section 14 (described later) to the memory devices 31. The number of continuous LF processes is hereinafter indicated by (F) in some cases.

The number of new LF processes is the number of LF commands to be issued by the LF executing section 14 to the memory devices 31. The number of new LF processes is hereinafter indicated by (G) in some cases.

In the phase 3, the operational multiplicity (D) determined in the phase 2 and the number of continuous LF processes are used. It is assumed that an initial value of the number (F) of continuous LF processes is 0.

The LF controller 12 compares the operational multiplicity (D) determined in the phase 2 with the number (F) of continuous LF processes.

When the operational multiplicity (D) is equal to or larger than the number (F) of continuous LF processes, the LF controller 12 calculates the number (G) of new LF processes based on the following Equation (2).

The number (G) of new LF processes=the operational multiplicity (D)−the number (F) of continuous LF processes (2)

For example, when the operational multiplicity (D) is 4 (D=4), and the number (F) of continuous LF processes is 2 (F=2), the number (G) of new LF processes is 2 (G=4−2).

When the operational multiplicity (D) is equal to the number (F) of continuous LF processes or, for example, when the operational multiplicity (D) is 2 (D=2) and the number (F) of continuous LF processes is 2 (F=2), the number (G) of new LF processes is 0 (G=2−2=0).

When the operational multiplicity (D) is smaller than the number (F) of continuous LF processes or, for example, when the operational multiplicity (D) is 1 (D=1) and the number (F) of continuous LF processes is 2 (F=2), the number (G) of new LF processes is 0. In addition, the LF controller 12 sets the value of the operational multiplicity (D) as the number (F) of continuous LF processes.

The LF controller 12 manages the number (the number (F) of continuous LF processes) of LF commands issued by the LF executing section 14 and determines the number (G) of new LF processes so that the number (G) of new LF processes is equal to the operational multiplicity (D).

Then, the LF controller 12 notifies the determined number of continuous LF processes and the determined number of new LF processes to the LF executing section 14.

When the operational multiplicity (D) is smaller than the number (F) of continuous LF processes, the LF controller 12 releases, for example, the resource such as the memory region included in the memory 106 and used for the LF command process after the completion of the LF command process. By executing this, the number of LF command processes being executed is reduced.

The LF executing section 14 issues one or more LF commands to the memory devices 31. The LF executing section 14 acquires the number, determined by the LF controller 12, of new LF processes (the acquisition of the number of LF commands), generates the same number of LF commands as the acquired number of new LF processes, and issues the generated LF commands to the memory devices 31 in parallel (the issuance of the LF commands).

Thus, the LF executing section 14 simultaneously issues, to the memory devices 31, the same number of LF commands as the LF command multiplicity determined by the LF controller 12 (multiple issuance).

For example, each of the LF commands is a command to enable a process such as the writing of a BCC to a specified region (unformatted region) within a memory device 31. The LF commands are known and will not be described in detail.

In a process of issuing a single LF command, the LF executing section 14 searches an unformatted region of a memory device 31 and issues the LF command to execute the LF on the unformatted region.

When any of the LF commands issued by the LF executing section 14 is completed, the process returns to the phase 2 to update the operational multiplicity (D). For example, when the LF command process is completely executed on a single LF command, the process returns to the phase 2 to update the operational multiplicity (D).

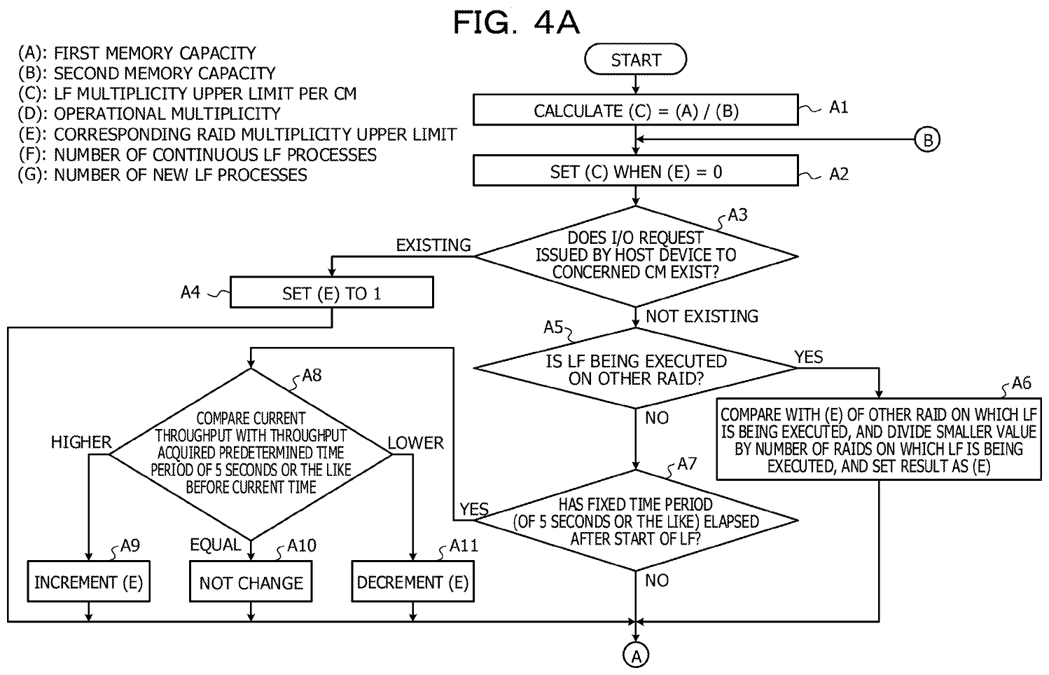

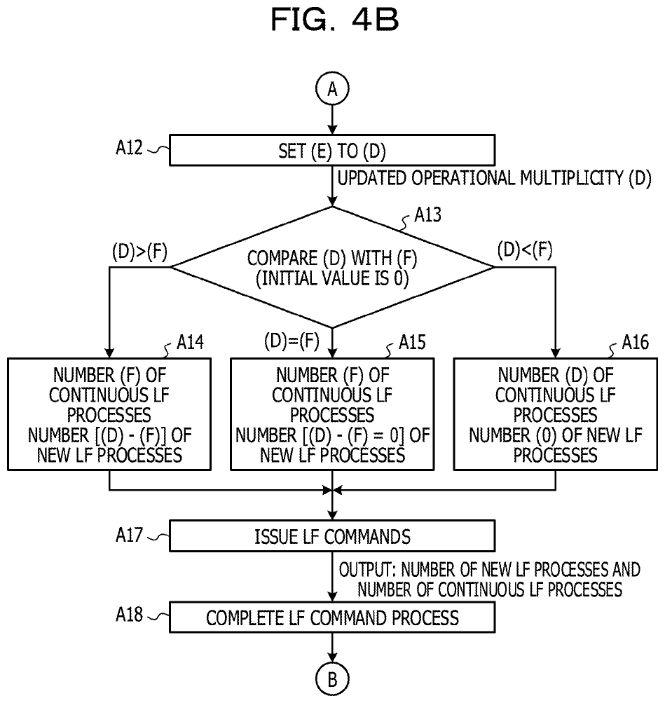

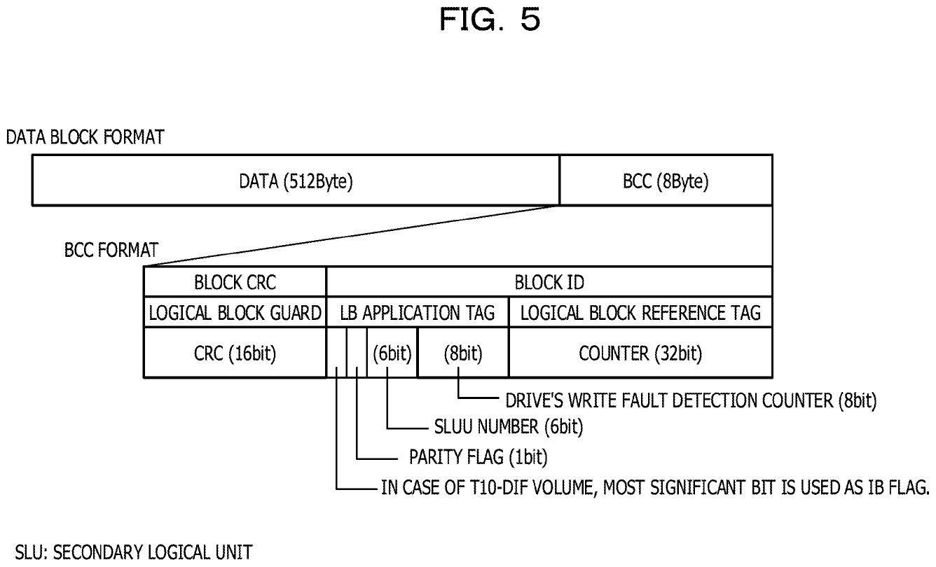

A process to be executed by the LF controller 12 of the storage device 1 configured as described above as the example of the embodiment is described with reference to a flowchart (steps A1 to A18) illustrated in FIGS. 4A and 4B.

For example, the LF is started when the operator issues a command to execute the formatting. First, the LF controller 12 executes the process of the phase 1. For example, in step A1, the LF controller 12 calculates the LF multiplicity upper limit (C) per CM based on the aforementioned Equation (1). For example, the LF controller 12 calculates the “LF multiplicity upper limit (C) per CM”=the “first memory capacity (A)”/the “second memory capacity (B)”. The calculated LF multiplicity upper limit (C) per CM is output in the phase 1.

Next, the LF controller 12 executes the process of the phase 2. Steps A2 to A12 described below correspond to the process of the phase 2. The LF multiplicity upper limit (C) per CM that has been calculated in step A1 is input in the phase 2.

In step A2, when a corresponding RAID multiplicity upper limit (E) of a RAID to be processed is 0, the LF controller 12 sets the LF multiplicity upper limit (C) per CM to the corresponding RAID multiplicity upper limit (E). In the case where the LF multiplicity upper limit (C) per CM is set to the initial value of the corresponding RAID multiplicity upper limit (E), the corresponding RAID multiplicity upper limit (E) does not exceed the LF multiplicity upper limit (C) per CM in the following processes.

In step A3, the LF controller 12 confirms whether an I/O request has been issued by the host device 2 to the concerned CM 100. When the I/O request issued by the host device 2 exists (“existing” in step A3), the process proceeds to step A4.

In step A4, the LF controller 12 sets 1 to the corresponding RAID multiplicity upper limit (E). After that, the process proceeds to step A12.

When the I/O request issued by the host device 2 does not exist (“not existing” in step A3) as a result of the confirmation of step A3, the process proceeds to step A5.

In step A5, the LF controller 12 confirms whether the concerned CM 100 is executing the LF on another RAID. When the concerned CM 100 is executing the LF on the other RAID (Yes in step A5), the process proceeds to step A6.

In step A6, the LF controller 12 compares the corresponding RAID multiplicity upper limit (E) of the RAID to be processed with a corresponding RAID multiplicity upper limit (E) of the other RAID on which the LF is being executed. Then, the LF controller 12 sets, as a new corresponding RAID multiplicity upper limit (E), a value obtained by dividing a smaller one of the corresponding RAID multiplicity upper limits (E) by the number of RAIDs being operated under management by the concerned CM 100.

The LF controller 12 compares the corresponding RAID multiplicity upper limit (E) of the RAID to be processed with the corresponding RAID multiplicity upper limit (E) of the other RAID on which the LF is being executed. Then, the LF controller 12 sets, to the corresponding RAID multiplicity upper limit (E), a quotient (4/2=2) of the division of the smaller corresponding RAID multiplicity upper limit (E) (for example, 4) by the number (for example, 2) of RAIDs. After that, the process proceeds to step A12.

When the concerned CM 100 is not executing the LF on the other RAID as a result of the confirmation of step A5 (No in step A5), the process proceeds to step A7.

In step A7, the LF controller 12 confirms whether a time period elapsed after the start of the LF is equal to or longer than the fixed time period T (of, for example, 5 seconds). When the time period elapsed after the start of the LF is shorter than the fixed time period T as a result of the confirmation (No in step A7), the process proceeds to step A12.

On the other hand, when the time period elapsed after the start of the LF is equal to or longer than the fixed time period T as a result of the confirmation (Yes in step A7), the process proceeds to step A8. In step A8, the LF controller 12 compares current throughput of memory devices 31 forming the RAID to be processed with throughput, acquired at a time that is earlier than the current time by the predetermined time period T (of, for example, 5 seconds), of the memory devices 31.

When the current throughput is higher than the throughput acquired at the time that is earlier than the current time by the predetermined time period T (“Higher” in step A8), the LF controller 12 increments the corresponding RAID multiplicity upper limit (E) (in step A9). The current throughout higher than the throughput acquired at the time that is earlier than the current time by the predetermined time period T indicates that processing performance of the memory devices 31 is higher than processing performance, acquired at the time that is earlier than the current time by the predetermined time period T, of the memory devices 31. Thus, the LF controller 12 determines that current processing performance of the storage device 1 is below the maximum processing performance of the storage device 1. Then, the LF controller 12 increases the LF command multiplicity.

When the current throughput is equal to the throughput acquired at the time that is earlier than the current time by the predetermined time period T (“Equal” in step A8), the LF controller 12 does not change the corresponding RAID multiplicity upper limit (E) (in step A10).

When the current throughput is lower than the throughput acquired at the time that is earlier than the current time by the predetermined time period T (“Lower” in step A8), the LF controller 12 decrements the corresponding RAID multiplicity upper limit (E) (in step All). The current throughout lower than the throughput acquired at the time that is earlier than the current time by the predetermined time period T indicates that the processing performance of the memory devices 31 decreases and is lower than the processing performance, acquired at the time that is earlier than the current time by the predetermined time period T, of the memory devices 31. Thus, the LF controller 12 determines that the current processing performance of the storage device 1 is at the maximum processing performance. Then, the LF controller 12 reduces the LF command multiplicity.

The LF controller 12 compares the current throughput of the memory devices 31 with the throughput, acquired at the time that is earlier than the current time by the predetermined time period T (of, for example, 5 seconds), of the memory devices 31, thereby determining whether the processing performance is below the maximum processing performance. Then, the LF controller 12 increases or reduces the LF command multiplicity based on whether the processing performance is below the maximum processing performance.

In step A12, the LF controller 12 sets the corresponding RAID multiplicity upper limit (E) to the operational multiplicity (D). By executing this, the operational multiplicity (D) is determined (updated). The updated operational multiplicity (D) is output in the phase 2.

Next, the LF controller 12 executes the process of the phase 3. Steps A13 to A16 described below correspond to the process of the phase 3. The operational multiplicity (D) updated in step A12 is input in the phase 3.

In step A13, the LF controller 12 compares the operational multiplicity (D) with the number (F) of continuous LF processes that is the number of incomplete LF commands issued by the LF executing section 14 to the memory devices 31. The initial value of the number (F) of continuous LF processes is 0 (F=0).

When the operational multiplicity (D) is larger than the number (F) of continuous LF processes (“(D)>(F)” in step A13), the LF controller 12 calculates the number (G) of new LF processes based on the aforementioned Equation (2) (in step A14). For example, the LF controller 12 calculates the number (G) of new LF processes by subtracting the number (F) of continuous LF processes from the operational multiplicity (D).

When the operational multiplicity (D) is equal to the number (F) of continuous LF processes (“(D)=(F)” in step A13), the LF controller 12 sets the number (G) of new LF processes to 0 (in step A15).

When the operational multiplicity (D) is smaller than the number (F) of continuous LF processes (“(D)<(F)” in step A13), the LF controller 12 sets the number (G) of new LF processes to 0. In addition, the LF controller 12 sets the operational multiplicity (D) as the number (F) of continuous LF processes (in step A16).

Then, the LF controller 12 notifies the determined number of continuous LF processes and the determined number of new LF processes to the LF executing section 14. The number (G), determined in any of steps A14 to A16, of new LF processes and the number (F) of continuous LF processes are output in the phase 3.

In step A17, the LF executing section 14 generates the same number of LF commands as the number (G) of new LF processes and issues the generated LF commands to the memory devices 31 in parallel.

When any of the LF commands issued by the LF executing section 14 is completely processed in step A18, the process returns to step A2 (of the phase 2).

As described above, in the storage device 1 as the example of the embodiment, the LF executing section 14 issues multiple LF commands to the memory devices 31 simultaneously in parallel (multiple issuance), thereby reducing the time period for executing the LF.

In addition, the LF controller 12 determines the number (LF command multiplicity) of LF commands to be issued in parallel, based on a processing state of the concerned CM 100 or processed states of the memory devices 31. Thus, the LF controller 12 may efficiently execute the LF.

In a state in which the I/O request issued by the host device 2 to the concerned CM 100 exists, the LF controller 12 does not simultaneously issue multiple LF commands (or the LF command multiplicity=1). Thus, while the process of the LF does not affect the I/O request from the host device 2, the performance of the storage device 1 may be maintained.

In the case where the LF controller 12 executes the LF on the memory devices 31 forming the RAID to be processed, when the LF is being executed on the other RAID, the LF controller 12 compares the corresponding RAID multiplicity upper limit (E) of the RAID to be processed with the corresponding RAID multiplicity upper limit (E) of the other RAID. Then, the LF controller 12 sets, as the operational multiplicity (D), a value (quotient) obtained by dividing a smaller one of the corresponding RAID multiplicity upper limits (E) by the number of RAIDs being operated under management by the concerned CM 100.

Thus, in a state in which multiple RAIDs are being operated in the storage device 1, when the LF is being executed on another RAID, a load of the concerned CM 100 may be reduced by reducing the multiplicity based on the number of RAIDs being operated.

In addition, the LF controller 12 compares the current throughput with the throughput acquired at the time that is earlier than the current time by the predetermined time period T. When the throughput increases and is higher than the throughput acquired at the time that is earlier than the current time by the predetermined time period T, the LF controller 12 increases the operational multiplicity (D) or the LF command multiplicity. Thus, when processing performance of the memory devices 31 is below the maximum processing performance of the memory devices 31, the LF controller 12 may increase the LF command multiplicity, thereby reducing the time period for executing the LF.

When the LF controller 12 compares the current throughput with the throughput acquired at the time that is earlier than the current time by the predetermined time period T, and the throughput decreases and is lower than the throughput acquired at the time that is earlier than the current time by the predetermined time period T, the LF controller 12 reduces the operational multiplicity (D) or the LF command multiplicity. When the processing performance of the memory devices 31 is at the maximum processing performance, loads of the memory devices 31 and the load of the concerned CM 100 may be reduced by reducing the LF command multiplicity, and it may be possible to inhibit a reduction in the processing performance of the storage device 1. As described above, in the storage device 1, one or more LF commands may be issued in accordance with the multiplicity based on the loads of the memory devices 31.

The LF controller 12 manages the number (or the number (F) of continuous LF processes) of LF commands issued by the LF executing section 14 and determines the number (G) of new LF processes so that the number (G) of new LF processes is equal to the operational multiplicity (D). Thus, the number (or the number (F) of continuous LF processes) of LF commands being executed may be reflected in the number (or the number (G) of new LF processes) of LF commands to be issued by the LF executing section 14, and LF processing performance of the concerned CM 100 may be reliably controlled.

For example, the LF command multiplicity is not excessively increased, and thus a resource (for example, a memory resource) of the storage device 1 is neither excessively nor fully used due to an excessive increase in the LF command multiplicity.

Techniques disclosed herein are not limited to the aforementioned embodiment and may include various modifications and changes without departing from the gist of the embodiment. The configurations described in the embodiment and the processes described in the embodiment may be selectively used. Alternatively, two or more of the configurations described in the embodiment may be combined, and two or more of the processes described in the embodiment may be combined.

For example, the number of CMs 100 included in the storage device 1 is not limited to 2 and may be 1 or 3 or more.

In addition, the number of memory devices 31 included in each of the DEs 30 is not limited to 4 and may be 3 or less or 5 or more. The RAIDs configured using the memory devices 31 may be changed and operated.

In the aforementioned embodiment, the LF controller 12 determines an increase or reduction in the throughput of the memory devices 31 after the start of the LF and changes the corresponding RAID multiplicity upper limit (E) or the operational multiplicity (D), but is not limited to this. For example, the LF controller 12 may use various information indicating load states and performance of the memory devices 31 to change the corresponding RAID multiplicity upper limit (E) (or the operational multiplicity (D)).

For example, the LF controller 12 may acquire input output per second (IOPS) or average response time for the memory devices 31 instead of the throughput of the memory devices 31, determine an increase or reduction in the TOPS or average response time for the memory devices 31, and change the corresponding RAID multiplicity upper limit (E) (or the operational multiplicity (D)). The TOPS or the average response time indicates the input and output performance.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage control system comprising:
one or more memories; and
one or more processors coupled to the one or more memories and the one or more processors configured to
acquire first processing performance of a storage device at a first time and second processing performance of the storage device at a second time before the first time,
perform determination of multiplicity of logical formatting for the storage device based on a difference between the first processing performance and the second processing performance, and
perform, based on the determined multiplicity, issuance of one or more logical formatting commands to the storage device.

2. The storage control system according to claim 1, wherein
the determination includes determining the multiplicity higher than current multiplicity when the first processing performance is higher than the second processing performance.

3. The storage control system according to claim 1, wherein
the determination includes determining the multiplicity lower than current multiplicity when the first processing performance is lower than the second processing performance.

4. The storage control system according to claim 1, wherein
the one or more processors are configured to determine an upper limit on the multiplicity by dividing a first memory capacity permitted to be used by the one or more processors to execute the logical formatting by a standard memory capacity determined based on a redundant array of inexpensive disks configuration.

5. The storage control system according to claim 1, wherein
the processor is configured to update the multiplicity to 1 in response to receiving an input or output request from an external device.

6. The storage control system according to claim 1, wherein
the issuance includes determining a specific number of logical formatting commands to be issued, based on the multiplicity and a number of issued incomplete logical formatting commands, and issue the one or more logical formatting commands corresponding to the determined specific number.

7. The storage control system according to claim 1, wherein
the determining is determination of the multiplicity based on a number of one or more redundant arrays of inexpensive disks when the logical formatting is executed in the one or more redundant arrays of inexpensive disks from among a plurality of redundant arrays of inexpensive disks other than a first redundant array of inexpensive disks formed by the storage device.

8. The storage control system according to claim 7, wherein
the determination based on the number of the one or more redundant arrays of inexpensive disks includes determining the multiplicity based on a result of dividing a smaller one of a first multiplicity upper limit set for the first redundant array of inexpensive disks and a second multiplicity upper limit set for a second redundant array of inexpensive disks of the one or more redundant arrays of inexpensive disks by the number of one or more redundant arrays of inexpensive disks.

9. A computer-implemented storage control method comprising:
acquiring first processing performance of a storage device at a first time and second processing performance of the storage device at a second time before the first time;
determining multiplicity of logical formatting for the storage device based on a difference between the first processing performance and the second processing performance; and
issuing, based on the determined multiplicity, one or more logical formatting commands to the storage device.

10. The storage control method according to claim 9, wherein
the determining includes determining the multiplicity higher than current multiplicity when the first processing performance is higher than the second processing performance.

11. The storage control method according to claim 9, wherein
the determining includes determining the multiplicity lower than current multiplicity when the first processing performance is lower than the second processing performance.

12. The storage control method according to claim 9, further comprising:
determining an upper limit on the multiplicity by dividing a first memory capacity permitted to be used by the one or more processors to execute the logical formatting by a standard memory capacity determined based on a redundant array of inexpensive disks configuration.

13. The storage control method according to claim 9, further comprising:
updating the multiplicity to 1 in response to receiving an input or output request from an external device.

14. The storage control method according to claim 9, wherein
the issuing includes determining a specific number of logical formatting commands to be issued, based on the multiplicity and a number of issued incomplete logical formatting commands, and issuing the one or more logical formatting commands corresponding to the determined specific number.

15. The storage control method according to claim 9, wherein
the determining is determination of the multiplicity based on a number of one or more redundant arrays of inexpensive disks when the logical formatting is executed in the one or more redundant arrays of inexpensive disks from among a plurality of redundant arrays of inexpensive disks other than a first redundant array of inexpensive disks formed by the storage device.

16. The storage control system according to claim 7, wherein
the determination includes determining the multiplicity based on a result of dividing a smaller one of a first multiplicity upper limit set for the first redundant array of inexpensive disks and a second multiplicity upper limit set for a second redundant array of inexpensive disks of the one or more redundant arrays of inexpensive disks by the number of one or more redundant arrays of inexpensive disks.

17. A non-transitory computer-readable medium storing instructions executable by one or more computers, the instructions comprising:
one or more instructions for acquiring first processing performance of a storage device at a first time and second processing performance of the storage device at a second time before the first time;
one or more instructions for determining multiplicity of logical formatting for the storage device based on a difference between the first processing performance and the second processing performance; and
one or more instructions for issuing, based on the determined multiplicity, one or more logical formatting commands to the storage device.
